(19) United States
(12) Patent Application Publication
(10) Pub. No.: US 2026/0240278 A1
(43) Pub. Date: Aug. 20, 2026

(54) SHOE SOLES AND RELATED FOOTWEAR

(71) Applicant: A. FERREIRA & PEREIRA, LDA. (BOLFLEX), SENDIM FLG (PT)

(72) Inventor: António TEIXEIRA FERREIRA, LIXA (PT)

(21) Appl. No.: 19/544,921

(22) Filed: Feb. 19, 2026

(30) Foreign Application Priority Data
Feb. 20, 2025 (PT) 120058

(51) Int. Cl. A43B 1/10; A43B 7/36; A43B 13/02; B29C 45/00; B29C 45/14; B29K 7/00; B29K 9/06; B29K 21/00; B29K 105/00; B29L 31/50

(52) U.S. Cl. CPC A43B 1/10; A43B 7/36; A43B 13/026; B29C 45/0001; B29C 45/14336; B29K 2007/00; B29K 2009/06; B29K 2021/00; B29K 2105/0023; B29L 2031/504

(57) ABSTRACT

The invention relates to a footwear sole (1) comprising an outer sole (2) and a pin (3), wherein the pin (3) is fitted into a hole in the outer sole (2) and projects through the upper face of the outer sole (2). The pin (3) is made from a first elastomeric composition comprising a first elastomer, an electrically conductive compound and an oil. The pin (3) is fitted and fixed in the hole by injection moulding.

Inserting the pin (3) directly into the outer sole (2) by injection moulding results in a fluid-tight seal.

The invention relates to a footwear sole applicable in the technical field of manufacturing earthing footwear, that is, footwear with structural features that allow the connection of an electrically conductive element to the earth.

### TECHNICAL FIELD

The present invention relates to a footwear sole applicable in the technical field of manufacturing earthing footwear, that is, footwear with structural features that allow the connection of an electrically conductive element to the earth.

Earthing footwear has a first conventional application, which relates to earthing safety footwear, which has means for protecting the wearer of the footwear from lightning strikes, through the provision of an alternative path to the earth, from lighting strikes or accumulated static charges that cause a voltage difference between the wearer's body and the earth.

The second application relates to the earthing (or grounding) of the footwear and aims to allow the person to establish a direct electrical connection with the earth. The idea behind this footwear is that direct contact with the earth can have health benefits, such as reducing inflammation, improving blood circulation and improving the balance of the body's biological rhythms.

The practice of earthing is based on the hypothesis that direct contact with the surface of the earth can help to balance electrical charges in the human body.

Earthing is a concept that is based on direct connection between the human body and the earth's electrical field. This process can be carried out by simply walking barefoot on natural surfaces such as grass, soil or sand, allowing the body to come into contact with the earth's energy. The fundamental idea behind this concept is that electrons present in the earth can be transferred directly to the body, providing significant benefits to human health.

When the earth's electrons come into contact with the body, they help to neutralise free radicals, which are unstable molecules associated with cell ageing, inflammation and various chronic health conditions. The presence of these electrons has the effect of reducing oxidative stress and inflammation in the body, promoting a state of balance and well-being. This process can also contribute to reducing pain, since it acts to relieve muscle and joint tension. In addition, studies suggest that regular earthing can improve sleep quality, facilitating faster and more efficient recovery after intense physical activities, which is essential for maintaining good health and performance.

### PRIOR ART

Some known earthing footwear has a sole made from conductive materials, such as leather or some type of metal compound, which allows the electrons to flow between the body and the ground.

Alternatively, earthing footwear includes a conductive pin connected to a sole, wherein the conductive pin is rigid and is manufactured from metal or carbon materials, the sole is pierced to allow the insertion of the pin, and the pin establishes electrical contact between the wearer's body and the earth. However, the opening for the conductive pin to pass through, however small, allows interactions with impurities present in the soil, water or other external elements to occur. As a result, these elements can come into direct contact with the bottom of the wearer's foot, creating potential for contamination or deterioration of the functional integrity of the footwear. In addition, this earthing footwear does not guarantee continuous insulation and sealing, which compromises the effectiveness of the insulation and the protection of the footwear. The absence of proper sealing results in a lack of impermeability of the connection between the pin and the sole, allowing external factors to interfere with the performance of the footwear.

This structural defect directly impacts the performance of conventional earthing footwear, since the point of contact between the conductive pin and the sole is not properly fixed or sealed, leading to decreased durability, protection and, consequently, efficiency of the product as a whole.

### Problems of the Prior Art

The earthing footwear known in the prior art that uses a conductive pin connected to the sole is not fully sealed, resulting in an oscillating point of contact with the ground, without a fixed insertion zone or stable contact between the conductive pin and the sole. This type of configuration can lead to inconsistent performance of the footwear, since the point of contact with the ground is not permanently fixed, which can compromise the stability of the wearer during use of the footwear.

In addition, wearing earthing footwear that uses pins or other conductive metal elements results in the emission of unwanted noise on contact with the ground. This noise is not only uncomfortable for the wearer, but is accompanied by a lack of effectiveness in the absorption of impacts and the transmission of energy between the contact surface and the wearer.

In footwear that uses conductive pins or metal parts, the contact surface tends to be uneven, having imperfections that directly affect the efficiency and balance of the wearer. These irregularities can generate imbalances during wear, compromising the experience of comfort and safety.

Another limiting factor of earthing footwear that uses pins or other conductive metal elements is the dependence on external suppliers for the supply of pins, which can lead to variability in the quality and availability of these components. This dependence can have an impact on the production chain and affect the consistency of the end product, compromising the performance and reliability of the footwear as a whole.

### Solution to the Problems of the Prior Art

The present invention solves the problems of the prior art through the development of a footwear sole (1) comprising an outer sole (2) and a pin (3), wherein the pin (3) is configured to be fitted into the hole (4) of the outer sole (2) and to project through the outer sole (2) from the lower face of the outer sole (2), and wherein the pin (3) is made from a first elastomeric composition comprising a first elastomer, an electrically conductive compound and an oil. The pin (3) is fitted into the hole (4) by injection moulding, wherein the pin (3) is fitted and fixed in the hole (4) of the outer sole (2) during said injection moulding.

The fact that the pin (3) has elastic properties makes it possible to fix the pin (3) in the hole (4) of the outer sole (2) during injection moulding, resulting in a full and stable seal during wear of the earthing footwear.

### Advantageous Effects of the Invention

The fluid-tight, seamless and jointless seal resulting from the insertion of the pin (3) directly into the outer sole (2) by means of injection moulding provides a fully sealed solution, without any external interference, eliminating points of vulnerability where infiltrations of unwanted elements such as water or dirt could occur, ensuring that the footwear retains its effectiveness and durability.

In addition, the use of the fluid-tight seal allows a more balanced and functional design of the footwear, since the pin (3) remains correctly positioned during wear of the footwear, providing a more ergonomic and efficient product. The production process, which takes place in two steps, allows an optimised ground contact thickness, minimising any negative impact on the wearing of the footwear. This approach contributes to reducing imbalances and discomfort for the wearer, providing a more stable and pleasant experience.

Another significant benefit of the use of the present invention is the elimination of the noise caused by the use of conductive metal parts, which not only improves the quality of use, but also reduces the possibility of auditory discomfort for the wearer.

In addition, the invention creates an effective protective barrier between the wearer's foot and the ground, providing greater comfort and safety. This solution improves the connection of the footwear with the terrain, in a stable and controlled manner.

The use of soles made from elastomeric materials and elastomeric conductive pins offers a significant increase in the abrasion and wear resistance of footwear, contributing to an increase in the durability of the product, reducing the damage caused by continuous use and prolonging the service life of the footwear.

As an indirect consequence, the reduction of wear on the shoes results in a reduction in environmental impact, since the need to replace footwear is reduced, thus contributing to sustainability.

### BRIEF DESCRIPTION OF THE FIGURES

In order to facilitate an understanding of the principles according to the embodiments of the present invention, reference will be made to the embodiments illustrated in the figures and to the language used to describe them. In any case, it should be understood that there is no intention to limit the scope of the present invention to the content of the figures. Any subsequent changes or modifications to the inventive features illustrated herein, as well as any additional applications of the principles and embodiments of the invention illustrated, which would form part of the routine practice of a person skilled in the art in possession of this description, are considered to be within the scope of the claimed invention.

FIG. 1 illustrates a bottom view of a footwear sole (1) including an outer sole (2) connected to a pin (3);

FIG. 2 illustrates a side view of a footwear sole (1) including an outer sole (2) connected to a pin (3);

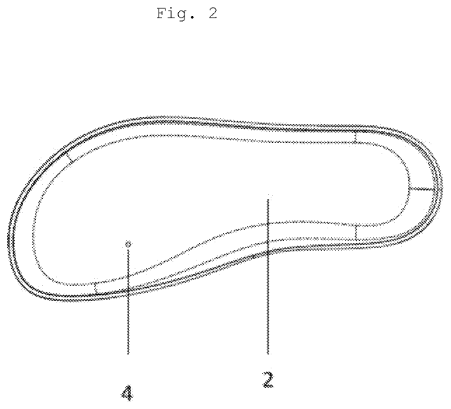

FIG. 3 illustrates a top view of an outer sole (2) including a hole (4);

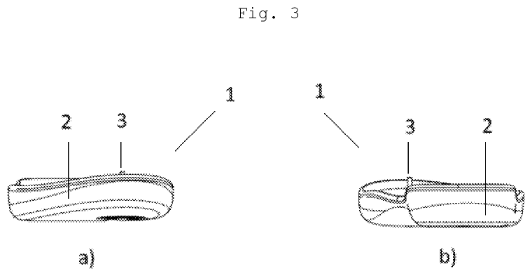

FIG. 4 illustrates a front view and a rear view of a footwear sole (1) including an outer sole (2) connected to a pin (3);

FIG. 5 illustrates views of a pin (3) including a base (5).

### DESCRIPTION OF THE EMBODIMENTS

The present invention relates, in a first aspect, to a footwear sole (1) comprising:
an outer sole (2); and
a pin (3); wherein
   the outer sole (2) comprises an upper face, a lower face and a hole (4), wherein the hole (4) passes orthogonally through the outer sole (2); and wherein
   the pin (3) is configured to be fitted into the hole (4) of the outer sole (2) and to project through the outer sole (2) from the lower face of the outer sole (2); and wherein the pin (3) is made from a first elastomeric composition; and wherein
   the outer sole (2) is made from a second elastomeric composition comprising a second elastomer;
   characterised in that
   the first elastomeric composition comprises:
a first elastomer; and
an electrically conductive compound selected from the group consisting of carbon, carbon nanotubes, graphene, carbon black, recovered carbon black, carbon fibres, graphite, and mixtures thereof; and
an oil selected from the group consisting of a mineral oil, a vegetable oil, a synthetic oil, and mixtures thereof.

The incorporation of an electrically conductive compound into the pin (3) makes the footwear sole (1) capable of channelling the electrical charge from the earth directly to the human body, establishing an efficient circuit for the transfer of electrons from the ground to the body. This process, known as “earthing therapy”, aims to neutralise free radicals in the body, which are unstable molecules that can cause damage to cells and tissues over time. Through this charge transfer, the footwear sole (1) allows the body to recover its natural electrical balance, contributing to reducing oxidative stress and promoting a sense of well-being.

In addition to neutralising free radicals, the continuous flow of electrons can help to improve blood circulation, reduce inflammation and provide relief from muscle and joint pain. The cumulative effect of this interaction with the earth's electric field can also promote deeper and more restorative sleep, helping the body to recover after intense physical or psychological effort.

The pin (3), by virtue of its elastic properties, integrates perfectly into the footwear sole (1) during and after one-step injection moulding, by means of a hermetically closed and fluid-tight connection, ensuring that the “earthing” process is continuous and efficient, without any external interference.

The footwear sole (1) with its elastic properties does not alter the normal use of the footwear, contributing to wearer comfort. At the same time, the fluid-tight connection between the pin (3) and the outer sole (2) allows for proper sealing between the two components, preventing external elements such as water, dust or other contaminants from interfering with the conductivity of the pin (3), as well as ensuring that the footwear maintains constant and efficient contact with the ground, regardless of the type of terrain the wearer is on, whether on grass, soil, concrete or other surfaces.

The seal between the pin (3) and the outer sole (2) also ensures that the footwear operates optimally in all weather conditions, being resistant to wear caused by different contact surfaces, resulting in consistent performance over time, allowing functional and effective earthing, regardless of the environmental conditions.

The outer sole (2) made from an injection moulded elastomeric composition, combined with the elastomeric properties of the conductive pin (3), offers a unique combination of durability and wear resistance, which is essential for continuous and efficient performance of the invention.

In addition, the outer sole (2) made from a second elastomeric composition and the pin (3) made from a first elastomeric composition provide the wearer with a feeling of comfort when walking or during physical activity. This doubly elastic flexibility allows the footwear sole (1) to conform to the natural movements of the foot, providing an ergonomic and comfortable experience. At the same time, it maintains a firm and stable connection with the ground, which is crucial to ensure the efficient and continuous conduction of energy from the earth to the human body. During injection moulding, the pin (3) is thus permanently fixed in the hole (4) of the outer sole (2), resulting in the fluid-tight seal between the outer sole (2) and the pin (3).

The incorporation of the electrically conductive compound in the first elastomeric composition also ensures that the pin (3) is capable of maintaining the effectiveness of electron transfer, which is important for the process of neutralising free radicals in the body.

The effectiveness of the footwear sole (1) according to the invention is directly related to the ability of the footwear sole (1) to conduct the transfer of electrons from the earth to the human body, allowing an efficient connection between the wearer and the earth's electric field.

The electrical potential of the earth typically varies between −10 and −30 volts under normal conditions. A shoe with the footwear sole (1) is configured to allow the body to maintain an optimal voltage difference with the ground, ranging from 0 to −30 volts, preferably from −10 volts to −30 volts. This electrical potential range allows a continuous flow of electrons, creating a direct and effective connection between the wearer and the earth's electric field.

The current flowing through the body during earthing is usually in the range of 1 μA to 10 μA. Shoes made with the footwear sole (1) facilitate this level of current, ensuring that the body is properly “earthed”, the resistance to the passage of current through the footwear sole (1) being in the range of 10 to 20 kilo ohms. If the current flow is less than 1 μA, the effectiveness of the footwear sole (1) and the shoe constructed with it could be reduced. The value of 10 μA should be the upper limit, as this is a safe and effective current level for neutralising the electrical imbalances of the body without causing harm. Any value greater than this would be outside the typical “earthing” effect.

The impedance of the human body when “earthed” typically ranges from 1,000 ohms to 100,000 ohms, depending on factors such as skin moisture, conductivity and other physiological variables. In order for shoes produced with the footwear sole (1) according to the invention to be effective, they must reduce the impedance between the body and the ground. The lower the impedance, the more efficient the earthing will be. The footwear sole (1) has measured impedance values in the range of 10,000 ohms to 15,000 ohms.

The oil used in the first elastomeric composition imparts specific properties to the end material, such as flexibility, strength, durability and better processability during its manufacture. The oils help to modify the viscosity of the elastomeric composition, facilitating the mixing and extrusion process, and can also influence properties such as the hardness and elasticity of the end product. The vegetable oils that can be used include soya oil, canola oil, olive oil, sunflower oil, and mixtures thereof. Synthetic oil is a type of oil manufactured using controlled chemical processes, rather than being directly refined from crude oil, as is the case with conventional mineral oils. It is created to imitate and improve on the properties of mineral oils. The synthetic oils that can be used include polyalfalolefins, synthetic esters and silicone oils, and mixtures thereof. Mineral oils include aromatic oils, paraffinic oils and naphthenic oils. The oils help to make the elastomer matrix soft and supple, making it easier to mould and work. In addition, they reduce the viscosity of the rubber compounds, facilitating operations such as mixing, extrusion and calendering, and improve the mixing and compatibility of the different components in the formula of the elastomeric composition, ensuring homogeneous distribution of fillers and other additives.

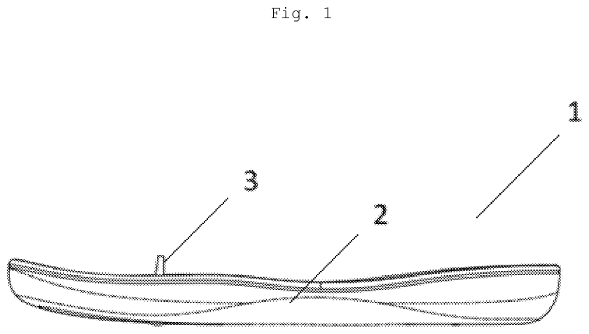

In the particularly preferred embodiments of the present invention, the body of the pin (3) is positioned in a front portion of the outer sole (2), wherein the front portion comprises the first longitudinal third of the outer sole (2). Even more preferably, as illustrated in FIG. 1, the pin (3) is positioned off-centre in an area adjacent to an edge of the outer sole (2).

Preferably, the perimeter of a cross-section of the body of the pin (3) is substantially the same as the perimeter of a cross-section of the hole (4) at the same level relative to the base of the outer sole (2).

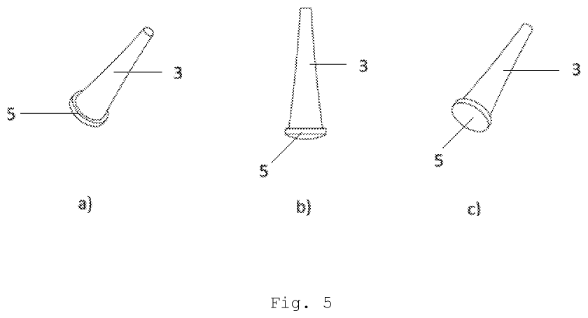

In the preferred embodiments of the present invention, as illustrated in FIG. 5, the body of the pin (3) has a frustoconical shape. The frustoconical shape allows the best fit and fixing between the pin (3) and the hole (4) positioned in the outer sole (2) during injection moulding, and to this end, the inner surface of the hole (4) also has a frustoconical shape. In this embodiment of the footwear sole (1), the lower end portions of the pin (3) and of the hole (4) preferably have the largest area of the cross-section of the truncated cone.

In other particularly preferred embodiments, as illustrated in FIG. 5, the pin (3) comprises a base (5), wherein the base (5) has a larger perimeter than the perimeter of the cross-section of the lower end portion of the body of the pin (3). In these embodiments, the base (5) fully covers the hole (4) and is flush with the contact area of the outer sole (2) with the ground.

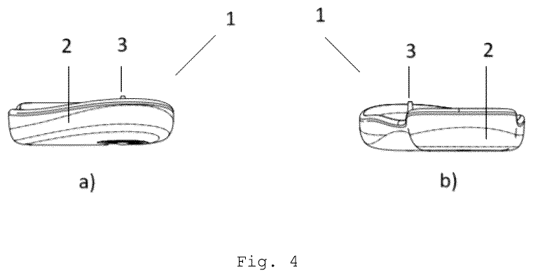

In other particularly preferred embodiments, the lower face of the outer sole (2) comprises a recess, wherein the hole (4) passes orthogonally through the outer sole (2) to said recess. FIG. 4a) illustrates said recess, which houses the lower end portion of the pin (3). When the pin (3) includes the base (5), the base (5) is preferably configured to be positioned on said recess and to cover the hole (4). The base (5) thus fully covers the hole (4) and is flush with the contact area of the outer sole (2) with the ground.

Preferably, the first elastomer of the first elastomeric composition, from which the pin (3) is made, is selected from the group consisting of styrene-butadiene rubber, natural rubber, styrene-ethylene-butylene-styrene rubber, polyurethane, polyester, polyolefins, ethylene-vinyl acetate rubber, nitrile rubber, silicone rubber, chloroprene rubber, butadiene rubber, isoprene rubber, butyl rubber, epoxy rubber, fluorinated rubber, chlorinated rubber, acrylonitrile rubber, fluorosilicone rubber, chlorosulphonated polyethylene rubber, perfluoroelastomer rubber, epichlorohydrin rubber, chlorinated polyethylene rubber, propylene-diene rubber, polychloroprene rubber, polyacrylate rubber, polysulphide rubber, urethane rubber, thermoplastic rubber, vulcanised thermoplastic rubber, fluorelastomer rubber, chloroprene rubber, chloroprene rubber, polybutadiene rubber, isobutylene-isoprene rubber, nitrile-hydrogenated rubber, mixtures thereof and copolymers thereof. In the particularly preferred embodiments, the first elastomeric composition comprises styrene-butadiene rubber.

Preferably, the fraction of the first elastomer in the first elastomeric composition is 40 to 70% by mass in relation to the total mass of the first elastomeric composition, and the fraction of the electrically conductive compound in the first elastomeric composition is 10 to 50% by mass in relation to the total mass of the first elastomeric composition, and the fraction of the oil in the first elastomeric composition is 1 to 20% by mass in relation to the total mass of the first elastomeric composition.

Even more preferably, the fraction of the first elastomer in the first elastomeric composition is 50 to 60% by mass in relation to the total mass of the first elastomeric composition, and the fraction of the electrically conductive compound in the first elastomeric composition is 25 to 35% by mass in relation to the total mass of the first elastomeric composition, and the fraction of the oil in the first elastomeric composition is 5 to 15% by mass in relation to the total mass of the first elastomeric composition.

In the particularly preferred embodiments, the fraction of the first elastomer in the first elastomeric composition is 52 to 58%, for example 56%, by mass in relation to the total mass of the first elastomeric composition, and the fraction of the electrically conductive compound in the first elastomeric composition is 30 to 35%, for example 34%, by mass in relation to the total mass of the first elastomeric composition, and the fraction of the oil in the first elastomeric composition is 8 to 12%, for example 10%, by mass in relation to the total mass of the first elastomeric composition.

SBR (styrene-butadiene rubber) is a synthetic rubber composed of approximately 23% styrene, mixed with polybutadiene. It is combined with various additives such as paraffin oil, antioxidants, antiozonants, UV stabilisers, reinforcing fillers and accelerators. These additives are responsible for improving the properties of the material, providing greater durability and wear and oxidation resistance, and improved performance under different environmental conditions. The result is a rubber with excellent elastic properties, thermal stability and abrasion resistance.

The outer sole (2) is made from a second elastomeric composition comprising a second elastomer. Even more preferably, the second elastomer of the second elastomeric composition is selected from the group consisting of styrene-butadiene rubber, natural rubber, styrene-ethylene-butylene-styrene rubber, polyurethane, polyester, polyolefins, ethylene-vinyl acetate rubber, nitrile rubber, silicone rubber, chloroprene rubber, butadiene rubber, isoprene rubber, butyl rubber, epoxy rubber, fluorinated rubber, chlorinated rubber, acrylonitrile rubber, fluorosilicone rubber, chlorosulphonated polyethylene rubber, perfluoroelastomer rubber, epichlorohydrin rubber, chlorinated polyethylene rubber, propylene-diene rubber, polychloroprene rubber, polyacrylate rubber, polysulphide rubber, urethane rubber, thermoplastic rubber, vulcanised thermoplastic rubber, fluorelastomer rubber, chloroprene rubber, chloroprene rubber, polybutadiene rubber, isobutylene-isoprene rubber, nitrile-hydrogenated rubber, mixtures thereof and copolymers thereof.

Preferably, the second elastomeric composition can also include the same type of oil as used in the preparation of the first elastomeric composition, wherein the fraction of the oil in the second elastomeric composition is 1 to 20% by mass in relation to the total mass of the second elastomeric composition.

Preferably, the footwear sole (1) additionally comprises a midsole positioned on the upper face of the outer sole (2). Even more preferably, the midsole is also made from the second elastomeric composition and is fixed to the outer sole (2) by means of injection moulding.

Preferably, in the footwear preparation process, an upper portion of the pin (3) can be removed by means of a cut or excision, so that the end portion of the pin (3) aligns with the upper face of the outer sole (2) or of the midsole.

In other embodiments, the footwear sole (1) additionally comprises a heel connected to the anterior portion of the lower face of the outer sole (2).

The present invention relates, in a second aspect, to footwear comprising the footwear sole (1) as defined in the first aspect of the invention. Within the scope of the present invention, footwear include shoes, trainers, pumps, boots, sandals, slippers and safety footwear.

The present invention relates, in a third aspect, to a process for producing the footwear sole (1) as defined in the first aspect of the invention, wherein the process is performed by injection moulding.

### EXAMPLES

An example of the first elastomeric composition includes 56.1% by mass of styrene-butadiene rubber, 33.7% by mass of the electrically conductive compound and 10.2% by mass of aromatic oil, wherein the mass percentages are established in relation to the total mass of the first elastomeric composition.

The second elastomeric composition can comprise recycled elastomers, fillers, accelerators, additives, oils and pigments. An example of the second elastomeric composition comprises around 20% natural rubber, around 20% recycled rubber and/or elastomers, around 13% synthetic elastomers, around 15% fillers, around 7% accelerators, around 10% additives, around 10% oil and around 5% pigment, wherein the percentages relate to the total mass of the second elastomeric composition.

An example of the configuration of the injection moulding machine for injection moulding the pin (3) includes the operating parameters listed in Table 1.

TABLE 1

| Parameter | Value/Unit | |
|---|---|---|
| Closing pressure | 160 bar (16 MPa) | |
| Injection pressure | 120 bar (12 MPa) | |
| Screw pressure | 80 bar (8 MPa) | |
| Injection chamber temperature | 65° | C. |
| Screw temperature | 65° | C. |
| Mould temperature | 170° | C. |
| Temperature of first | 60° | C. |
| elastomeric composition | | |
| Cycle time | 70 | s |
| Injection speed | 2200 | cc/min |

An example of the configuration of the injection moulding machine for injection moulding the outer sole (2) includes the operating parameters listed in Table 2.

TABLE 2

| Parameter | Value/Unit | |
|---|---|---|
| Closing pressure | 160 bar (16 MPa) | |
| Injection pressure | 120 bar (12 MPa) | |
| Screw pressure | 80 bar (8 MPa) | |
| Injection chamber temperature | 60° | C. |
| Screw temperature | 60° | C. |
| Mould temperature | 160° | C. |
| Temperature of second | 140° | C. |
| elastomeric composition | | |
| Cycle time | 160 | s |
| Injection speed | 2000 | cc/min |

As used in this description, the expressions “around” and “approximately” refer to a range of values of 10% more or less than the specified number.

As used throughout this patent application, the term “or” is used inclusively rather than exclusively, unless exclusive use is clearly defined in a specific situation. In this context, a phrase such as “X uses A or B” should be interpreted as including all relevant inclusive combinations, for example “X uses A”, “X uses B” and “X uses A and B”.

As used throughout this patent application, the indefinite articles “one”, “a” or “an” should generally be interpreted as “one or more” unless singular use is clearly defined in a specific situation.

As disclosed in this description, terms relating to examples should be interpreted as being for the purpose of illustrating an example of something and not as indicating a preference.

As used in this description, the expression “substantially” means that the actual value is within the range of around 10% of the desired value, variable or related limit, particularly within around 5% of the desired value, variable or related limit, or especially within around 1% of the desired value, variable or related limit.

The subject matter described above is provided by way of illustration of the present invention and should not be interpreted as limiting it. The terminology used for the purpose of describing specific embodiments according to the present invention should not be interpreted as limiting the invention. As used in the description, definite and indefinite articles in the singular should be interpreted as including the plural, unless the context of the description explicitly indicates otherwise. It will be understood that the terms “comprise” and “include”, when used in this description, specify the presence of the features, elements, components, steps and related operations, but do not exclude the possibility of other features, elements, components, steps and operations also being envisaged.

All alterations, provided that they do not modify the essential features of the claims below, should be considered to be within the scope of protection of the present invention.

### LIST OF REFERENCE SIGNS

1. A footwear sole
2. An outer sole
3. A pin
4. A hole in the outer sole
5. A base of the pin

### LIST OF CITATIONS

---.

1. A footwear sole (1) comprising:
an outer sole (2); and
a pin (3); wherein
the outer sole (2) comprises an upper face, a lower face and a hole (4), wherein the hole (4) passes orthogonally through the outer sole (2); and wherein
the pin (3) is configured to be fitted into the hole (4) of the outer sole (2) and to project through the outer sole (2) from the lower face of the outer sole (2); and wherein
the pin (3) is made from a first elastomeric composition; and wherein
the outer sole (2) is made from a second elastomeric composition comprising a second elastomer;
characterised in that
the first elastomeric composition comprises:
a first elastomer; and
an electrically conductive compound selected from the group consisting of carbon, carbon nanotubes, graphene, carbon black, recovered carbon black, carbon fibres, graphite, and mixtures thereof; and
an oil selected from the group consisting of a mineral oil, a vegetable oil, a synthetic oil, and mixtures thereof.

2. The footwear sole (1) according to the claim 1, characterised in that the body of the pin (3) has a frustoconical shape.

3. The footwear sole (1) according to the claim 1, characterised in that the pin (3) comprises a base (5), wherein the base (5) has a larger perimeter than the perimeter of the cross-section of the lower end portion of the body of the pin (3).

4. The footwear sole (1) according to the claim 1, characterised in that the lower face of the outer sole (2) comprises a recess, wherein the hole (4) passes orthogonally through the outer sole (2) to said recess.

5. The footwear sole (1) according to claims 3 and 4, characterised in that the base (5) of the pin (3) is configured to be positioned on said recess and to cover the hole (4).

6. The footwear sole (1) according to the claim 1, characterised in that the first elastomer of the first elastomeric composition is selected from the group consisting of styrene-butadiene rubber, natural rubber, styrene-ethylene-butylene-styrene rubber, polyurethane, polyester, polyolefins, ethylene-vinyl acetate rubber, nitrile rubber, silicone rubber, chloroprene rubber, butadiene rubber, isoprene rubber, butyl rubber, epoxy rubber, fluorinated rubber, chlorinated rubber, acrylonitrile rubber, fluorosilicone rubber, chlorosulphonated polyethylene rubber, perfluoroelastomer rubber, epichlorohydrin rubber, chlorinated polyethylene rubber, propylene-diene rubber, polychloroprene rubber, polyacrylate rubber, polysulphide rubber, urethane rubber, thermoplastic rubber, vulcanised thermoplastic rubber, fluorelastomer rubber, chloroprene rubber, chloroprene rubber, polybutadiene rubber, isobutylene-isoprene rubber, nitrile-hydrogenated rubber, mixtures thereof and copolymers thereof.

7. The footwear sole (1) according to the claim 1, characterised in that the fraction of the first elastomer in the first elastomeric composition is 40 to 70% by mass in relation to the total mass of the first elastomeric composition, and the fraction of the electrically conductive compound in the first elastomeric composition is 10 to 50% by mass in relation to the total mass of the first elastomeric composition, and the fraction of the oil in the first elastomeric composition is 1 to 20% by mass in relation to the total mass of the first elastomeric composition.

8. The footwear sole (1) according to the claim 7, characterised in that the second elastomer of the second elastomeric composition is selected from the group consisting of styrene-butadiene rubber, natural rubber, styrene-ethylene-butylene-styrene rubber, polyurethane, polyester, polyolefins, ethylene-vinyl acetate rubber, nitrile rubber, silicone rubber, chloroprene rubber, butadiene rubber, isoprene rubber, butyl rubber, epoxy rubber, fluorinated rubber, chlorinated rubber, acrylonitrile rubber, fluorosilicone rubber, chlorosulphonated polyethylene rubber, perfluoroelastomer rubber, epichlorohydrin rubber, chlorinated polyethylene rubber, propylene-diene rubber, polychloroprene rubber, polyacrylate rubber, polysulphide rubber, urethane rubber, thermoplastic rubber, vulcanised thermoplastic rubber, fluorelastomer rubber, chloroprene rubber, chloroprene rubber, polybutadiene rubber, isobutylene-isoprene rubber, nitrile-hydrogenated rubber, mixtures thereof and copolymers thereof.

9. The footwear sole (1) according to the claim 1, characterised in that it additionally comprises a midsole positioned on the upper face of the outer sole (2).

10. The footwear sole (1) according to the claim 1, characterised in that it additionally comprises a heel connected to the anterior portion of the lower face of the outer sole (2).

11. A footwear characterised in that it comprises the footwear sole (1) as defined in the claim 1.

12. A process for producing a footwear sole (1) as defined in the claim 1, characterised in that it is performed by injection moulding, wherein the pin (3) is fitted and fixed in the hole (4) of the outer sole (2) during said injection moulding.
